(19) United States
(12) Patent Application Publication
(10) Pub. No.: US 2026/0339113 A1
(43) Pub. Date: Oct. 29, 2026

(54) OPTICAL ARRANGEMENT FOR PHOTOFRAGMENTATION

(71) Applicants: Thermo Fisher Scientific (Bremen) GmbH, Bremen (DE); California Institute of Technology, Pasadena, CA (US)

(72) Inventors: Viatcheslav Kovtoun, Boise, ID (US); Alexander Makarov, Bremen (DE); Michael Roukes, Pasadena, CA (US)

(73) Assignees: Thermo Fisher Scientific (Bremen) GmbH, Bremen (DE); California Institute of Technology, Pasadena, CA (US)

(21) Appl. No.: 19/107,212

(22) PCT Filed: Aug. 30, 2023
(86) PCT No.: PCT/US2023/073200

§ 371 Date: Feb. 27, 2025

Related U.S. Application Data
(63) Continuation-in-part of application No. 17/823,618, filed on Aug. 31, 2022, now Pat. No. 12,387,925.

(51) Int. Cl. G02B 27/12; G02B 3/08; H01J 49/42

(52) U.S. Cl. CPC G02B 27/123; G02B 3/08; G02B 27/126; H01J 49/4245

(57) ABSTRACT

An optical arrangement splits an optical beam into multiple beamlets and focuses each beamlet at a respective line. Each line is defined with reference to a respective spatially-separated location across at least one dimension, such that each beamlet photofragments distinct ions confined at the respective location. Each of the spatially-separated locations may correspond with a respective trapping region of one of an array of ion traps.

### TECHNICAL FIELD OF THE DISCLOSURE

The disclosure is concerned with an optical arrangement for photofragmentation. This can be used in a mass spectrometry system based on an array of ion traps.

### CROSS-REFERENCE TO RELATED APPLICATIONS

This application claims priority from U.S. patent application Ser. No. 17/823,618, filed 31 Aug. 2022, which is incorporated herein by reference.

### BACKGROUND TO THE DISCLOSURE

Mass spectrometry utilizes fragmentation of ionized molecules to obtain a molecular fingerprint. This facilitates techniques for identification of the molecule with higher specificity than molecular mass alone, for example tandem mass spectrometry (MS²) or MSⁿ analysis.

A range of fragmentation techniques are known. One example is photofragmentation or photodissociation (PD), particularly using ultraviolet (UV) or infrared multiphoton (IRM) PD. Examples of this include: U.S. Pat. No. 10,276,357; US-2016/358766; U.S. Pat. Nos. 9,202,678; 7,618,806; 6,342,393; 6,642,516; 8,106,353, and WO-2013/005060. Further examples include: Payne, A. H., Glish, G. L., “Thermally assisted infrared multiphoton photodissociation in a quadrupole ion trap”, Anal. Chem. 73, 3542-3548 (2001); Kim, T. Y., et al, “Peptide photodissociation at 157 nm in a linear ion trap mass spectrometer”, Rapid Comm. Mass Spectrom. 19, 1657-1665 (2005); Brodbelt, J. S., Wilson, J. J., “Infrared multiphoton dissociation in quadrupole ion traps”, Mass Spectrom. Rev. 28, 390-424 (2009); Racaud, A., et al, “Wavelength-tunable ultraviolet photodissociation (UVPD) of heparin-derivated disaccharides in a linear ion trap”, J. Am. Soc. Mass Spectrom. 20, 1645-1651 (2009); Madsen, J. A., et al, “Top-down protein fragmentation by infrared multiphoton dissociation in a dual pressure linear ion trap”, Anal. Chem. 81, 8677-8686 (2009); and Ly, T., Julian, R. R., “Ultraviolet photodissociation: developments towards applications for mass-spectrometry-based proteomics” Angew. Chem. Int. Ed. 48, 7130-7137 (2009).

Referring to FIG. 1, there is shown an example schematic arrangement of a linear ion trap for photodissociation. The linear ion trap comprises: RF electrodes 10; and end apertures 20. Typically, a laser is located outside of the vacuum chamber of the mass spectrometer in which the linear ion trap is located. Special optics, flanges and windows (not shown) are provided to deliver photons via the laser beam 30 to the ions 40, which are usually trapped so as to be effectively located in a single spot. Ions are normally irradiated when they are trapped so that multiple pulses could be applied and resulting fragments can be contained within the same volume.

Typically, a fluence of at least or greater than 0.01-0.1 J/cm² is desirable for efficient PD, although it might increase by orders of magnitude for IRMPD if irradiated ions are trapped in a bath gas that could rapidly remove energy deposited into ions.

More recently, arrays of mass analyzers have been discussed, including in: U.S. Pat. No. 5,206,506 (which also suggests the use of IRMPD); U.S. Pat. Nos. 6,762,406; 8,203,118; 9,293,316; 9,607,817 (also suggesting the use of PD); U.S. Pat. No. 10,199,208; WO-2013/092923 (again suggesting using PD); and WO-2014/176316. The mass analyzers may be separate from an ion trap used for fragmentation. In most cases, collision-induced dissociation (CID) is used to fragment ions in these arrays. Fragmentation of ions is typically achieved sequentially.

It is desirable to improve implementation of PD in an array of mass analyzers, in particular, where each mass analyzer is or has an associated respective ion trap. Arrays of ion traps have been widely used for quantum computers and are increasingly utilized in mass spectrometry. Efficient implementation of PD can provide significant benefits for such arrays.

### SUMMARY OF THE DISCLOSURE

Against this background, there is provided an optical arrangement according to claim 1, a photofragmentation system in line with claim 14 and a method of processing an optical beam for photofragmentation in accordance with claim 20. Preferred and/or optional features are disclosed in the dependent claims.

A single laser beam can be split to provide simultaneously, at at least one point within each of multiple ion traps in an array, a respective focused laser energy (beamlet) for fragmentation of ions in the ion trap. An optical arrangement for splitting a single laser beam accordingly is therefore provided. Accordingly, a high energy per pulse may be utilized effectively to allow fast fragmentation.

The optical arrangement is advantageously used for an array of ion traps. In particular, each of the ion traps may have microscale dimensions, for example with a typical length of the trap being no more than 10 mm and optionally no more than 5 mm, 2 mm, 1 mm or 0.5 mm. A specific example of such ion traps may be a microscale electrostatic ion trap (μEST, for example as discussed in co-pending and commonly assigned U.S. patent application Ser. No. 17/823,618) or RF trap (for instance, as used in quantum computers). In such example arrays of ion traps, it may be possible to generate a single laser pulse with enough energy to fragment ions across a large number of traps simultaneously. In other words, the optical arrangement may provide at least (or more than) 10, 50, 100, 500 or even 1000 beamlets. Ions may be directed into and/or confined in the ion traps in a first direction with the optical (laser) beam being directed perpendicular to the first direction.

It has thus been recognized that fragmentation in an array of ion traps could be achieved, not by addressing each trap individually, but rather by splitting a (macroscopic) laser beam into a matching array of beamlets, each of which may be aligned with a single trap. Photofragmentation can thus be scaled to hundreds (and potentially thousands) of ion traps. In turn, this may allow increase of analysis throughput in these parallel channels.

Existing techniques do not consider the possibility of simultaneous photofragmentation of multiple ion samples in an array of traps, especially when the ion traps have miniature size. In the latter case, there is a significant mismatch between the typical size of the laser beam and a size of the ion beam in a trap, as well as between energy or repetition rate of laser pulses and required fluence or ion residence time.

One option for achieving the splitting uses a zone plate (using a structure similar to a Fresnel lens, but based on refraction rather than diffraction), which may be in the form of a segmented cylindrical lens (SCL). Other options may include an array of tilted micro-lenses or a fiber optic bundle. As well as splitting the beam, the optical arrangement focuses each beamlet onto a plane and more specifically onto a line. The focusing can be implemented by a cylindrical lens and/or SCL. Where a zone plate is used for splitting the beam, the focusing may be separate from it or provided by modifying the front or back surface of the cylindrical lens to integrate a SCL. Two implementations of SCL (or SCL integration) are considered for horizontal splitting and focusing: segments that are symmetrical around a sagittal (median) plane; and non-symmetrical segments.

The arrangements discussed above can be used to split the beam into multiple beamlets across a horizontal dimension or across a vertical dimension. For vertical splitting, a zone plate (which may be implemented as planar or as a multi-faceted prism) can be provided with a cylindrical lens for focusing. These can be integrated, similarly to the horizontal splitting arrangement. Alternatively, an array of tilted micro-lenses may provide both splitting and focusing, but with more complex manufacture. A splitting arrangement in a first (horizontal) direction can be provided together with a splitting arrangement in a second, orthogonal (vertical) direction to achieve focused beamlets at spatially-separated points across two dimensions (each point corresponding with a trapping region of a respective ion trap).

Alignment may be achieved by the combination of additional optics to raster the laser beam (beneficially in two dimensions) and detection pads (preferably four) around the region in which the beamlet is to be focused.

A laser (typically ultraviolet, UV or infrared, IR) is beneficially used together with the optical arrangement for photofragmentation. Then, the energy output of the laser is preferably sufficient for each beamlet to photofragment ions. In another sense, the laser and optical arrangement may be configured to achieve an optical fluence of at least 0.01 J/cm² at each separated location where ions are confined for fragmentation.

Implementations according to approaches discussed herein may be significantly better than scanning the laser from trap to trap sequentially. In view of the limited rate of, for example, UV lasers (typically <1-10 kHz), sequential fragmentation may become too slow and inefficient for a large number of traps in an array.

It will be noted that the multiple aspects of the disclosure may be combined.

### BRIEF DESCRIPTION OF THE DRAWINGS

The disclosure may be put into practice in a number of ways, and preferred embodiments will now be described by way of example only and with reference to the accompanying drawings, in which:

FIG. 1 shows an example schematic arrangement of a linear ion trap for photodissociation;

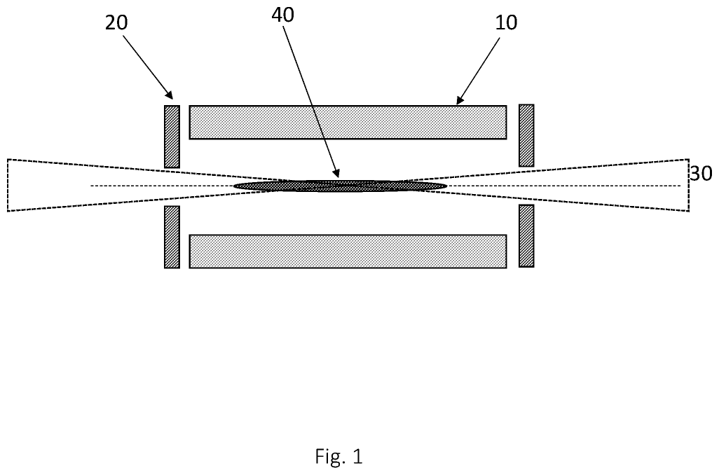

FIG. 2A shows a plan view of a first exemplary embodiment of an optical arrangement for splitting a laser beam into beamlets along a single dimension;

FIG. 2B shows a plan view of a second exemplary embodiment of an optical arrangement for splitting a laser beam into beamlets along a single dimension;

FIG. 2C shows a plan view of a third exemplary embodiment of an optical arrangement for splitting a laser beam into beamlets along a single dimension.

FIG. 3A illustrates a perspective view of a first Segmented Cylindrical Lens (SCL) of a stacked configuration, configured to split a beam into a unidimensional linear array of beamlets along a first dimension;

FIG. 3B illustrates a perspective view of a second SCL of a stacked configuration, configured to split a beam into a unidimensional linear array of beamlets along a second dimension;

FIG. 4A shows a plan view of an example SCL and ray traces of the SCL outputs at a one-dimensional array of focal points according to an embodiment of the disclosure;

FIG. 4B depicts an example data set for calculation of Center of Arc (CoA) locations in a SCL to achieve specific focal lengths;

FIG. 5A schematically illustrates an approach for using a cylindrical lens to produce multiple focal points in a one-dimensional array;

FIG. 5B shows a perspective view of an example implementation according to the approach of FIG. 5A;

FIG. 5C schematically depicts a cross-section through a facet of a zone plate as shown in FIG. 5B;

FIG. 5D schematically shows a multi-faceted prism in cross-section based on the facet shown in FIG. 5C;

FIG. 6A illustrates a perspective view of an array of horizontally elongated cylindrical micro-lenses having tilted axes;

FIG. 6B, there is shown a schematic cross-section of some of the cylindrical micro-lenses of FIG. 6A;

FIG. 7 shows a schematic perspective view of an optical arrangement for creating a two-dimensional array of beamlets based on a SCL and a combination of a multi-faceted prism with a cylindrical lens;

FIG. 8 illustrates a two-dimensional array of stacked micro-electrostatic traps (uESTs); and

FIG. 9 shows a perspective view of elements on an ion trap with additional features for optical beam alignment.

### DETAILED DESCRIPTION OF PREFERRED EMBODIMENTS

The focus of the present disclosure is on photofragmentation or photodissociation (PD) of multiple sets of ions, each of which is confined by a respective ion optical device (for instance, an ion trap). The details of how the ions are trapped is not necessarily relevant for the purposes of this disclosure.

U.S. patent application Ser. No. 17/823,618 filed on 31 Aug. 2022 and commonly assigned with the present disclosure discloses an array of micro-electrostatic traps (μESTs). Its details are incorporated by reference. These traps can be formed across one or two dimensions. The array could be large (hundreds of traps or more). Although the present disclosure is well suited for use with such an array of μESTs, it is not limited to such applications. For example, it may be used with an array of other types of ion optical device or ion trap, including RF traps. Typically, the size of such ion optical devices or ion traps is small (microscale), for example with a length of the trap being no more than 10 mm and optionally no more than 5 mm, 2 mm, 1 mm or 0.5 mm. Additionally or alternatively, the number of ion optical devices or ion traps in the array is usually large, for example at least (or more than) 10, 50, 100, 500 or 1000 devices or traps.

PD fragmentation of multiple sets of ions, each confined within separate ion optical devices or ion traps in an array is advantageously achieved by emission of a single pulse from a laser. An ultraviolet (UV) or infrared multiphoton (IRM) laser is typically used. The present disclosure provides an optical arrangement, which may include a splitter arrangement for spatially dividing the laser pulse output into beamlets to the different planes. Optionally, a lens array (particularly using miniature lenses, optionally with anti-reflective coating) may be provided for focusing each part of the pulse into a respective collimated beam.

Thus in a general sense, there may be considered an optical arrangement, configured to split an optical beam into multiple beamlets and focus each beamlet at a respective line (within a plane). Each line (or plane) is defined with reference to a respective spatially-separated location across at least one dimension (typically referenced as the z-dimension herein), such that each beamlet (or at least each of some of the beamlets) photofragments distinct ions confined at the respective location.

This may additionally (or alternatively) be considered as a method of processing an optical beam for photofragmentation, comprising: splitting the optical beam into multiple beamlets; and focusing each beamlet at a respective line, each line defined with reference to a respective spatially-separated location across at least one (z) dimension, such that each beamlet (or at least each of some of the beamlets) photofragments distinct ions confined at the respective location.

A number of exemplary optical arrangements and/or methods for achieving this will now be discussed (although the general sense discussed above will be referenced again below). Although these examples are shown providing a small number of beamlets (5 or 8, for instance), it will be understood that this is purely for illustrative purposes. These arrangements may be implemented with any number of beamlets, for example, at least or more than 10, 100, 500 or 1000.

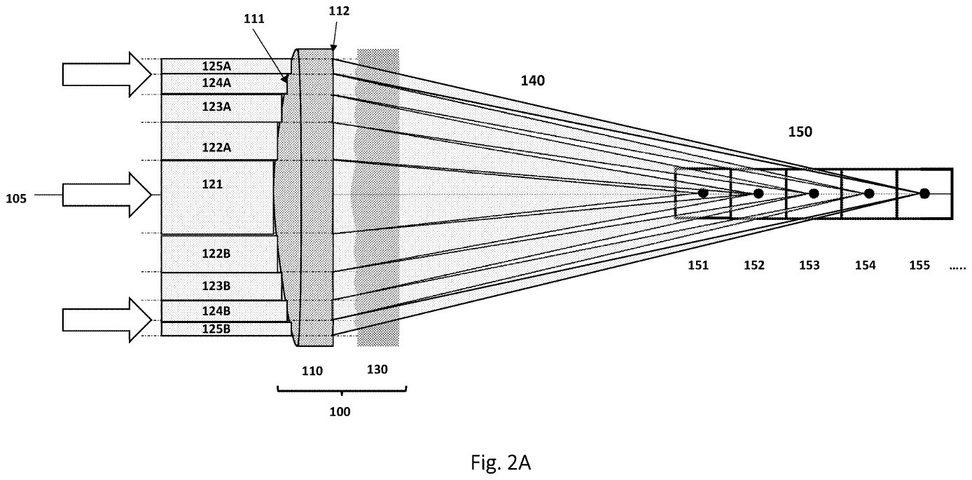

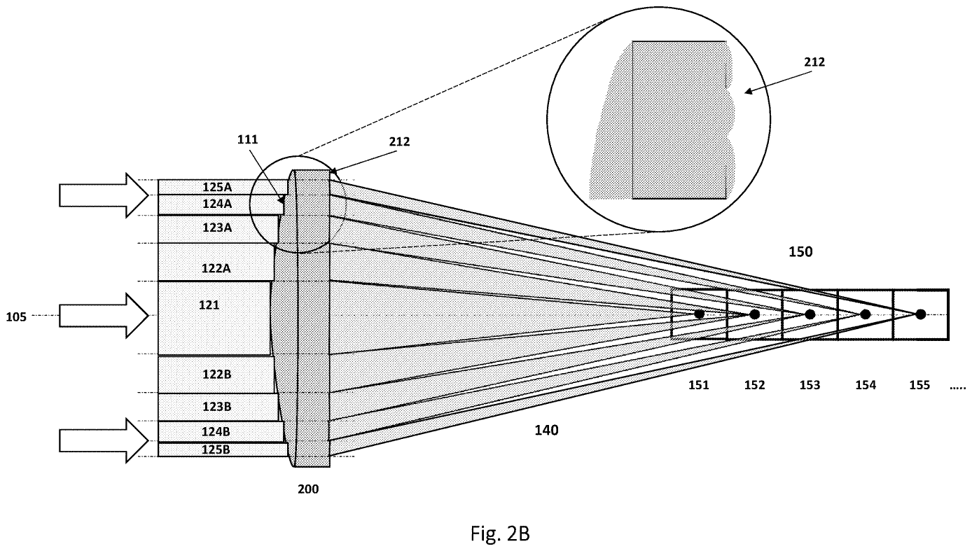

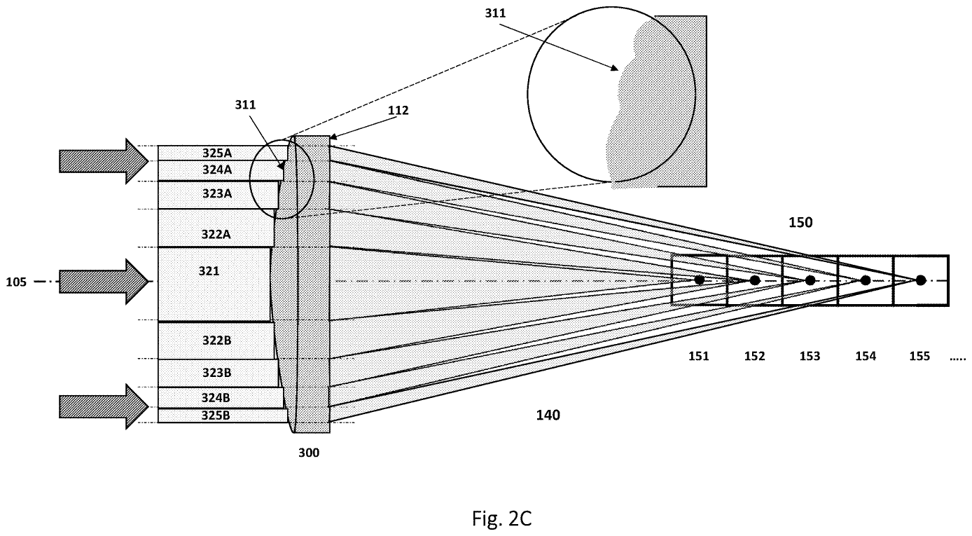

Referring now to FIG. 2A, there is shown a plan view of a first exemplary embodiment of an optical arrangement for splitting a laser beam into beamlets along a single dimension. The optical arrangement 100 comprises: a regular cylindrical lens 110; and a segmented cylindrical lens (SCL) 130. A single laser beam 105 is split by the optical arrangement 100 into beamlets 140, each of which is focused to a respective trapping region of an ion trap array 150. The trapping region of a first ion trap 151 defines a first focal point, the trapping region of a second ion trap 152 defines a second focal point, the trapping region of a third ion trap 153 defines a third focal point, the trapping region of a fourth ion trap 154 defines a fourth focal point and the trapping region of a fifth ion trap 155 defines a fifth focal point.

The laser beam 105 is first refracted by the cylindrical lens 110 (focusing lens). The cylindrical lens 110 can be a regular plano-convex lens with a curved front surface 111 and a flat back surface 112. An aim of this lens is to create a reference (base) focal point. This could be any of first to fifth focal points or any intermediate point.

The SCL 130 acts as a zone plate to focus beamlets at different focal points. For example, one of beamlets may be referenced to the first focal point (defined by the trapping region of a first ion trap 151). In this case, a corresponding segment on the SCL 130 may have a flat surface (no refraction). Other segments on SCL 130 have a curvature that alters the focal length provided by the lens 110 to create a subset of focal points, for example the second to fifth focal points (defined by the trapping regions of a second to fifth ion traps 152-155). This is achieved by zone segmentation on the front or back face of the SCL (zone plate) 130. Zones on the SCL 130 are cut or otherwise physically manufactured (and operate based on the property of refraction rather than diffraction). The zones all have equal areas to provide the same photon fluxes at the respective focal points. The power density on each of lenses should be orders of magnitude lower than the damage threshold for the lens material (typically, CaF₂, MgF₂ or a quartz glass for UV).

Nine zones are thereby created, four of which are mirrored on either side of a central zone 1 121 to create a central beamlet. These zones are: zone 2 122A, 122B creating two zone 2 beamlets; zone 3 123A, 123B creating two zone 3 beamlets; zone 4 124A, 124B creating two zone 4 beamlets; and zone 5 125A, 125B creating two zone 5 beamlets.

The SCL 130 is thereby customized for multiple focal points (or more specifically focal lines). To define the beamlets 140. The zone 1 beamlet is focused at the trapping region of the first ion trap 151. The zone 2 beamlets are focused at the trapping region of the second ion trap 152. The zone 3 beamlets are focused at the trapping region of the third ion trap 153. The zone 4 beamlets are focused at the trapping region of the fourth ion trap 154. The zone 5 beamlets are focused at the trapping region of the fifth ion trap 155. The position of the SCL 130 should be precise with respect to the focusing lens 110 ( ). This is to match ray traces after the focusing lens 110 with segments on the SCL 130.

It should be noted that providing the cylindrical lens 110 before the SCL 130 allows simplified manufacturing of curved surfaces in zones on the SCL 130. It can be easier to manufacture and permit high tolerances for large radii of curvature than small ones. The following quantitative example demonstrates how such large radii of curvature may result from this implementation.

For example, a radius of curvature, R, is defined by (N−1)*F, where N is the index of refraction and F is the lens focal length. For F=50 mm on a fused silica substrate (N=1.5608 at 193 nm wavelength), R=0.5608*50=28.04 mm. This is considered small for physical manufacture.

When a regular lens 110 sits in front of the SCL 130, a radius of curvature on segments may be significantly larger than 28 mm and only slightly different from a flat surface. For example, the furthest focal point (corresponding with the trapping region of the fifth ion trap 155) may be at the focus just of the cylindrical lens 110. Thus, a corresponding segment on the SCL 130 should have a flat surface with radius of curvature at infinity.

Other segments will each have a focal length (f₁ representing a focal length of the cylindrical lens 130 and f₂(n) representing a focal length of the nth segment of the SCL 130) according to the following formula, assuming the total number of beamlets is no, d represents the distance between the cylindrical lens 110 and the SCL 130 and Δ represents the pitch between focal points (ion traps):

$${f}_{2} ( n ) = ( {f}_{1} - d ) \times ( {f}_{1} \div \frac{{n}_{0} - n}{Δ - 1} )$$

Here, f₁ is 50 mm, d is 10 mm, Δ=0.5 mm and n₀=5, giving (where Rₙ represents the radius of curvature of the nth segment of the SCL 130):
f₂(5)=infinity, R₅=infinity (equivalent to a flat surface);
f₂(4)=3960 mm, R₄=2221 mm;
f₂(3)=1960 mm, R₃=1099 mm;
f₂(2)=1293 mm, R₂=725 mm; and
f₂(1)=960 mm, R₁=538 mm

Thus, the radii of curvature for the segment of the SCL 130 are significantly larger than the value of 28 mm when no front lens was used.

Referring now to FIG. 2B, there is shown a plan view of a second exemplary embodiment of an optical arrangement for splitting a laser beam into beamlets along a single dimension. This is similar to the first embodiment in some respects (although more preferred) and where the same features are shown, identical reference numerals have been employed. The optical arrangement 200 in this embodiment uses a modified zone plate or focusing lens. The front surface 111 of the focusing lens is a regular cylindrical lens surface. However, the back surface 212 of the focusing lens is modified. This is shown in the magnified portion of the back surface 212. The modifications to the back surface 212 create a segmented cylindrical lens that is customized for the multiple focal points. In this way, the same beamlets 140 are created from a single component and can be directed to the array 150. Manufacturing of this embodiment can be complicated, in view of the modifications made to the back surface 212. A planar back surface of the focusing lens can make manufacture more straightforward.

Referring now to FIG. 2C, there is shown a plan view of a third exemplary embodiment of an optical arrangement for splitting a laser beam into beamlets along a single dimension. This is also similar to the first embodiment in some respects (and more preferred than both the first and second embodiments) and where the same features are shown, identical reference numerals have been employed. The optical arrangement 300 in this embodiment again uses a modified zone plate or focusing lens. However, the front surface 311 is modified from a regular lens and incorporates a segmented cylindrical lens, customized for multiple focus points. This is shown in the magnified portion of the front surface 311. The back face 112 of the focusing lens is typically planar and simply allows the beamlets 140 to refract on the surface, which are then directed to the array 150. A planar back surface can make manufacture more straightforward than the embodiments shown in FIGS. 2A and 2B.

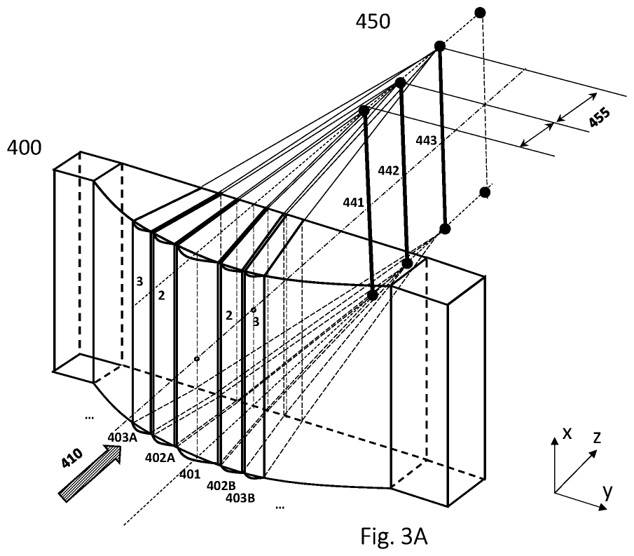

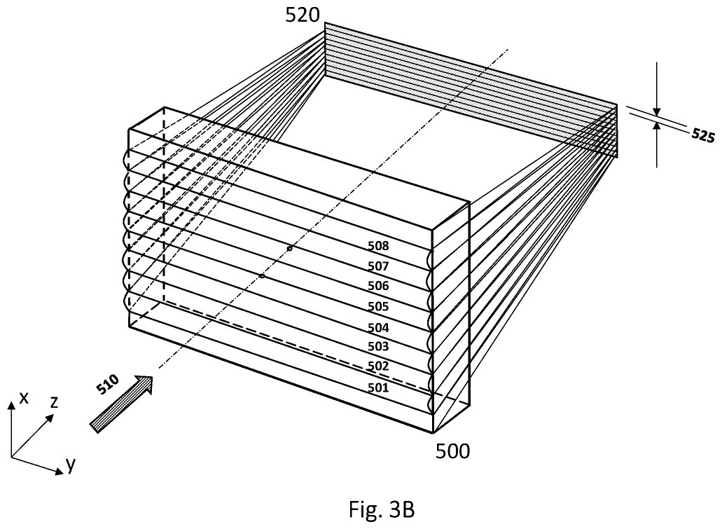

In practice, it is desirable to split the beam into beamlets across two dimensions. This can be achieved by using stacked SCLs, each configured to create a unidimensional linear array of beamlets. Referring next to FIG. 3A, there is illustrated a perspective view of a first SCL of a stacked configuration, configured to split a beam into a unidimensional linear array of beamlets along a first dimension (in this case, along the z-dimension as shown).

The SCL 400 is shown with segments that are symmetrical against the sagittal (median) plane. It comprises: a central segment 401, first outer segments 402A, 402B and second outer segments 403A, 403B. The central segment 401 is thus bordered by first outer segments labeled 402 on both sides off the sagittal plane (and similarly, second outer segments 403). The segments with the same label on both sides of the central segment 401 direct light to the same focal plane. In practice, any number of outer segments may be provided, but for the purposes of this example, it may be considered that the SCL 400 has seven outer segments on each side of the central segment 401. As explained with reference to FIG. 2C above, this results in beamlets focused on eight positions along a single dimension.

The beam 410 extends in the x-dimension, perpendicular to the z-dimension (the depth of the SCL 400) and the y-dimension (the width of the SCL 400 across the segments). Thus, the beamlets are focused at lines along a (horizontal) spaced region 450: the central segment 401 focuses at the first line 441; the first outer segments 402A, 402B focus at the second line 442; and the second outer segments 403A, 403B focus at the third line 443. The array pitch 455 (spacing between the lines) is typically 0.4-0.5 mm.

Reference is now made to FIG. 3B, in which there is illustrated a perspective view of a second SCL of a stacked configuration, configured to split a beam into a unidimensional linear array of beamlets along a second dimension (in this case, along the x-dimension as shown). The SCL 500 is shown with 8 central segments (501, 502, 503, 504, 505, 506, 507, 508) and 2 outer segments (that is, 10 segments in total). Only the 8 central segments are used for splitting and focusing beam 410. The result of this focusing (as discussed with reference to FIG. 2C above) is a one-dimensional spaced array of beamlets 520. The beamlets 520 are spaced in the (vertical) x-dimension. The array pitch 525 (spacing between the beamlets) is typically 0.1-0.5 mm or more typically 0.4-0.5 mm.

By way of guidance, the size of each lens of each SCL may vary between about 10×10 mm to about 40×40 mm. The size of each cell or ion trap (and accordingly, spacing between cells) may vary between 50 μm to 5 mm. Positioning accuracy of the beamlets may in the range of 5 to 200 μm. The two elements of FIGS. 3A and 3B work in two orthogonal planes, so there is a level of independence between them. Standard alignment procedure using micro-positioning tables (accuracy approximately in the tens to hundreds of micrometers) may be sufficient.

The result of stacking the first SCL 400 and the second SCL 500 creates a two-dimensional array of focal points. In this specific example, an 8×8 array of beamlets can thereby be provided. The SCLs shown in FIGS. 3A and 3B can thus be considered three-dimensional building blocks to create a two-dimensional array of focal points.

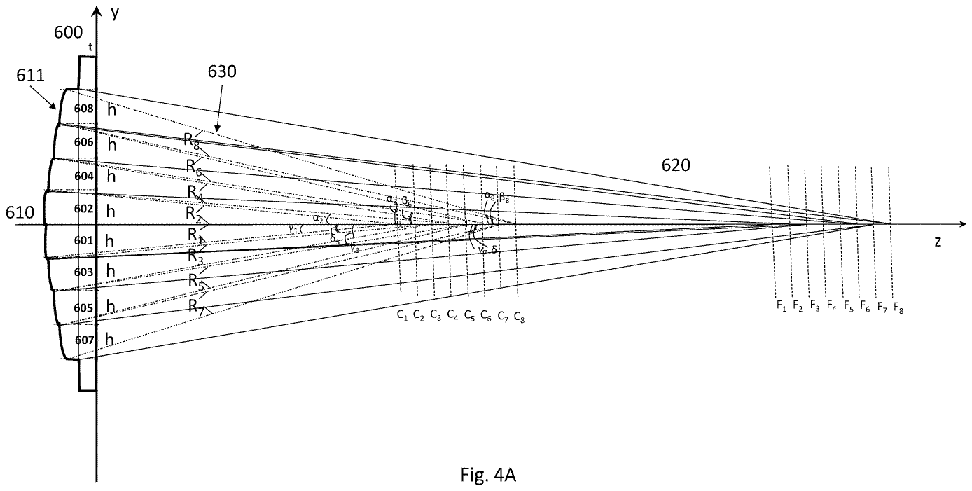

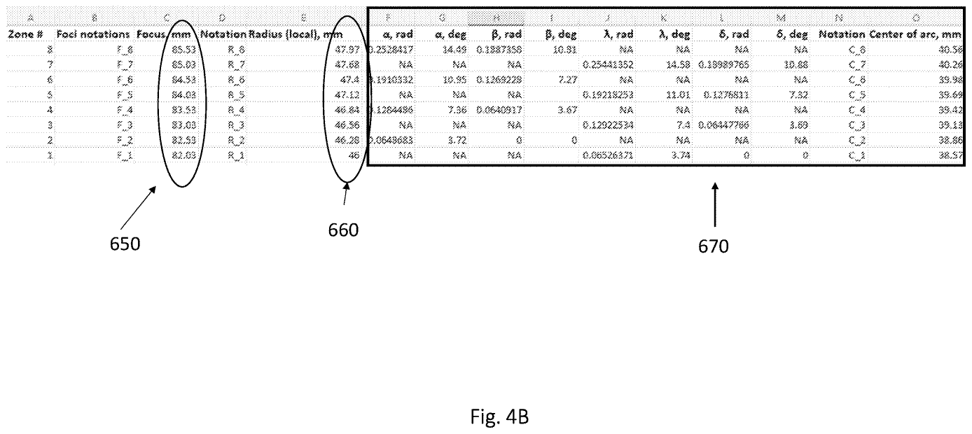

Further explanation of the construction of a SCL to provide a one-dimensional array of focal points is now provided. In that respect, reference is made to FIG. 4A, in which there is shown a plan view of an example SCL and ray traces of the SCL outputs at a one-dimensional array of focal points according to an embodiment of the disclosure. The focal points are labelled F₁-F₈, each of which would be matched with the center of a respective ion optical device or ion trap (for example, a respective μEST cell).

In this example SCL 600 comprises 8 segments 601, 602, 603, 604, 605, 606, 607, 608, arranged around a central axis 610. The height h of the segments in the SCL 600 and the base thickness t of the SCL 600 are marked.

This arrangement differs from the SCL shown in FIG. 3A. In this drawing, SCL 600 does not have segments symmetrically arranged around the sagittal plane. Each segment is a source for a unique focal plane. This allows a reduced number of physical segments (compared with those shown in FIGS. 2A, 2B and 2C), but a higher number of functional elements. This may improve manufacturability. In the SCL 600, the median plane is not a plane of symmetry. As a result, a sequence of segments on the lens with consecutively changing radii results. This may avoid significant overlapping between adjacent beamlets and thereby reduced interference from beamlets going to adjacent cells. This sequence may therefore be preferable compared with those shown in FIGS. 2A-3B, for example.

The ray paths 620 from the front face 611 of the SCL 600 in respect of each segment to the respective focal points F₁-F₈ are shown with solid lines for segments 603, 606, 607 and 608. Dotted lines 630 connect a respective edge on the front face 611 of each segment to a respective arc center of the segment C₁-C₈. These are labelled as radii, R₁-R₈ (each being a radius of curvature). For segment p that is above the center line (even numbered segments), the angle between the center line 610 and the furthest Rₚ is labelled αₚ and between the center line 610 and the closest Rₚ is labelled βₚ. For segment q that is below the center line (odd numbered segments), the angle between the center line 610 and the furthest R_{q} is labelled γ_{q} and between the center line 610 and the closest R_{q} is labelled δ_{q}. These angles are desirably defined accurately.

Equations for the edge segments: angles α,β,γ,δ and center of arc positions, C₂ₙ and C₂ₙ₋₁ are given by the following expressions, in the case n=4 (and where t represents the base thickness of the SCL 600), such that the total number of segments is 2*n=8.

$$sin {α}_{2 n} = n * \frac{h}{{R}_{2 n}} ; cos {α}_{2 n} = \frac{{C}_{2 n} + t}{{R}_{z n}} \qquad ( 1 )$$

$$sin {γ}_{2 n - 1} = n * \frac{h}{{R}_{2 n - 1}} ; cos {γ}_{2 n - 1} = \frac{{C}_{2 n - 1} + t}{{R}_{2 n - 1}} \qquad ( 2 )$$

$${C}_{2 n} = \sqrt{{R}_{2 n}^{2} - {( n h )}^{2}} - t \qquad ( 3 )$$

$${C}_{2 n - 1} = \sqrt{{R}_{2 n - 1}^{2} - {( n h )}^{2}} - t \qquad ( 4 )$$

For the even numbered segment angles α₂ₖ, β₂ₖ (above the center line 610), the angles satisfy the following expressions.

R₂ₖ*sin α₂ₖ=k*h, k=1 . . . 4 (5)

R₂ₖ*sin β₂ₖ=(k−1)*h, k=1 . . . 4 (6)

For the odd numbered segment angles, γ₂ₘ₋₁, δ₂ₘ₋₁ (below the center line 610), the angles satisfy the following expressions.

R₂ₘ₋₁*sin γ₂ₘ₋₁=m*h, m=1 . . . 4 (7)

R₂ₘ₋₁*sin δ₂ₘ₋₁=(m−1)*h, m=1 . . . 4 (8)

Based on the geometric relations previously detailed, the following expressions can be determined.

R₂ₖ*cos β₂ₖ−R₂ₖ₋₂*cos α₂ₖ₋₂=C₂ₖ−C₂ₖ₋₂ (9)

R₂ₘ₋₁*cos δ₂ₘ₋₁−R₂ₘ₋₃*cos γ₂ₘ₋₃=C₂ₘ₋₁−C₂ₘ₋₃ (10)

Thus, recurrent equations can be defined to find center of arc (CoA or position of center of curvature) locations starting from edge segments on both sides. The CoA locations for even segments are given by equation (11) and for odd segments by equation (12).

C₂ₖ₋₂=C₂ₖ+R₂ₖ₋₂*cos α₂ₖ₋₂−R₂ₖ*cos β₂ₖ (11)

C₂ₘ₋₃=x₂ₘ₋₁+R₂ₘ₋₃*cos γ₂ₘ₋₃−R₂ₘ₋₁*cos δ₂ₘ₋₁ (12)

In order to determine the design of the SCL, consideration is first made of a geometry of an array of focal points to produce. Then, practical design aspects are identified, for example: (1) distance from physical elements of optic to the location of the focal points array; and (2) manufacturability of multiple curved surfaces of optic element. The first aspect reflects geometry constrains such as interferences from other design elements. By default, a range 10 to 100 mm is assumed to be safe, to avoid those interferences. When a small spot size is desirable, relatively small focal distances (less than 100 mm) may be beneficial. Focal distances in the range of about 80 mm may be appropriate in some circumstances. There may be a trade-off between interferences and spot size. From the point of view of manufacturability, it is desirable that radii of curved surfaces should be manufacturable.

For example, it may be desired to provide a beamlet array of 8×8 elements with a pitch 0.5 mm of focal points on both axes. The geometry shown in FIG. 2C may be used to create a one-dimensional array of foci, located along the optical z-axis. A cylindrical lens of 30×30 mm may be well suited to the size of a beam after the beam expander. Many commercial cylindrical lenses are of this or a similar size. With a segment width of 3 mm and 8 elements, the segmented part of the lens may take 8×3 mm=24 mm. The rest of the lens area, 3 mm on each side, may be reserved for mounting the lens in the holder.

It should be noted that, as the width of each segment reduces, it becomes more challenging to make undercuts between segments, resulting in more elaborate manufacturing. A segment width of 3 mm should be amenable enough for processing. More broadly, the segment width is desirably in the range of 0.5 to 5 mm. The lens base width or thickness (t) has been assumed as 5 mm, especially as this appears standard based on optics catalogs.

For the purposes of the following calculations, a plano-convex geometry is assumed for all segments. Other shapes may be possible, for example best form lenses, but these may be more complicated and more expensive.

Referring next to FIG. 4B, there is depicted an example data set for calculation of CoA locations in a SCL to achieve specific focal lengths. This example calculation is for 8 total segments on the lens, with a pitch step (distances x₁-x₂, x₂-x₃, x₃-x₄, etc.) of 0.5 mm. Other parameters for this example include: material of fused silica; refraction index, N=1.5608 at 193 nm wavelength; segment width, h=3 mm; base thickness, t=5 mm. Lens size in this example case is approximately 30×30 mm. For calculation of the CoA locations focal lengths F₁, . . . , F₈ 650 (Column C) are first determined, according to the pitch step defined.

Looking at a first segment 601 shown in FIG. 4A, a plano-convex configuration may be assumed. Defining focal length as f, radius of curvature as Rand index of refraction as N, the relationship between the radius of curvature and focal length is defined by a formula:

R=F*(N−1) (13)

For a typical R value (for example 46 mm), the focal length may be calculated to be 82.03 mm. For N, its value at 193 nm wavelength was used, equal to 1.5608 (material—fused silica). All other focal lengths, for the other segments, may be set using a design-defined pitch of 0.5 mm. The remaining radii, R₁, . . . , R₈ 660 (Column E) are then calculated accordingly. The resultant values are not higher than 48 mm, which is quite normal by industry standards. Lenses of a similar radius may be found in optical catalogs routinely, so it is considered that such lenses may be readily manufactured.

Finally, the angles and CoA 670 (Column 0) can be determined using equations (1)-(12). Building the shape of every arc on the lens can be achieved by defining its center location and a start and end points. When the center of each arc is calculated and a radius is known, the arc may be fully defined by a start angle δ and a stop angle γ. As an example, angles δ₃ and γ₃ are for the segment 603 (FIG. 4A). It should be noted that, for segments 601 and 602, only one angle is needed.

The process starts with edge segments, which in this case are segments 607 and 608 shown on FIG. 4A. Angles α₈ and γ₇ are calculated first, from equations (1) and (2). Then, center of arc positions C₈ and C₇ are calculated from equations (3) and (4). The rest of angles are calculated using equations (5) to (8). All these angles are shown in the table of FIG. 4B, Columns F-M. For convenience, the angles are shown both in both degrees and radians.

Finally, centers of arcs C₁-C₆ for segments 1 to 6 are calculated using above calculated angles α, β, λ and δ and calculated values C₇ and C₃ in equations (11) and (12). Now the center location, the radius, the starting angle and the stop angle are defined for every arc.

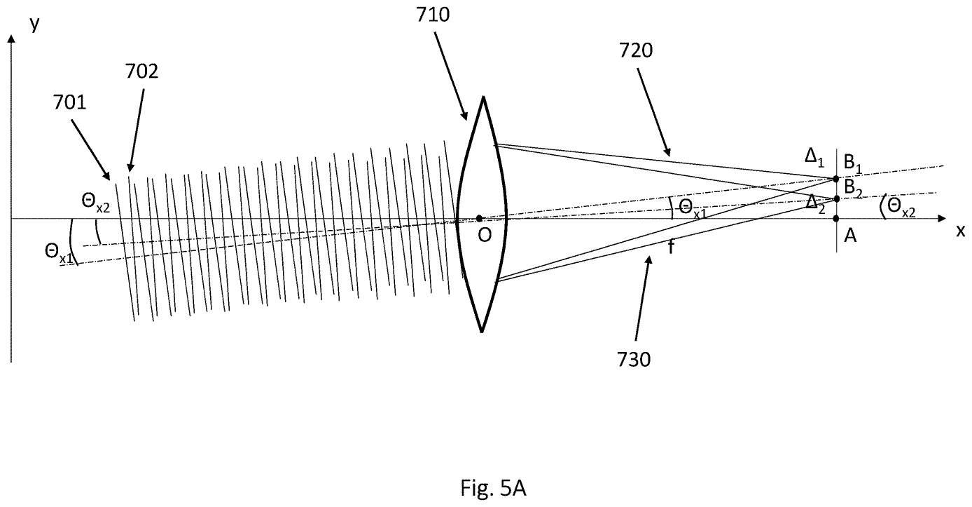

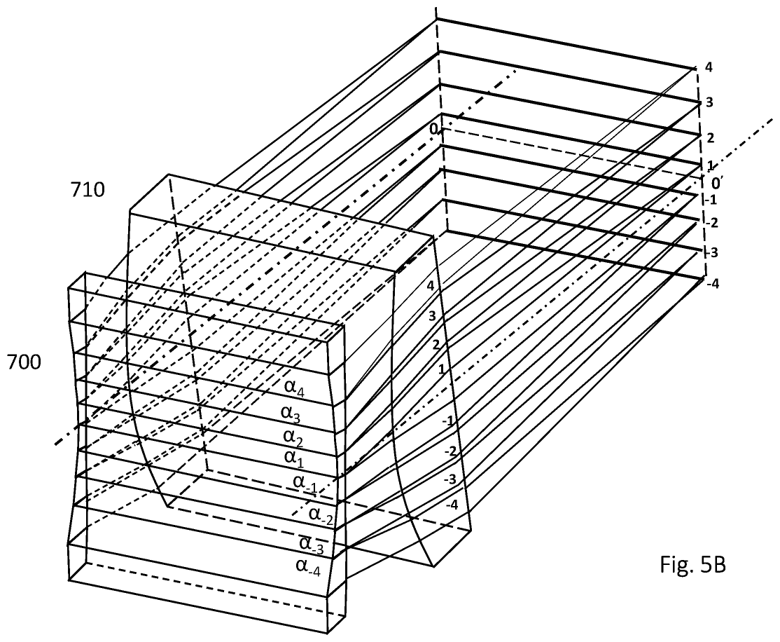

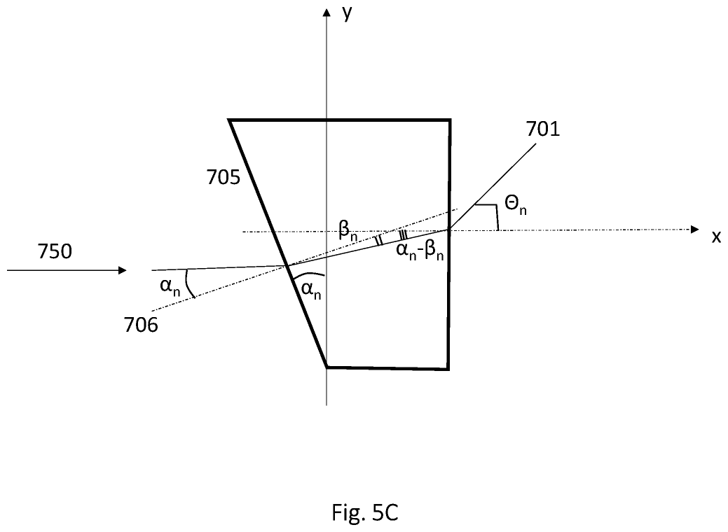

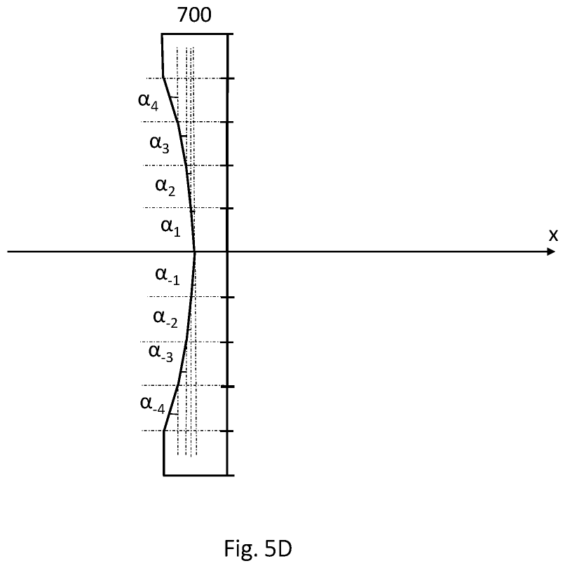

Reference is now made to FIG. 5A, in which there is schematically illustrated an approach for using a cylindrical lens to produce multiple focal points in a one-dimensional (vertical) array. This approach creates beamlets with multiple spatial frequencies and/or angles, for example using a planar zone plate, which may also be termed a multi-faceted prism (as discussed below with reference to FIG. 5B). A central x-axis and orthogonal y-axis are shown and a paraxial approximation is assumed.

A cylindrical focusing lens 710 is positioned parallel to the y-axis and with its center on the x-axis. Wavefronts for a first beamlet 701 at a first angle to the x-axis (Θₓ₁) and for a second beamlet 702 at a second, smaller angle to the x-axis (Θₓ₂) are shown. The focusing lens 710 focuses the first beamlet 701 to provide a first focused beamlet 720 that is focused at a first horizontal line B₁ at a first displacement along the y-axis, Δ₁. Similarly, the focusing lens 710 focuses the second beamlet 702 to provide a second focused beamlet 730 that is focused at a second horizontal line B₂ at a first displacement along the y-axis, Δ₂. Thus, a one-dimensional vertical array of focal lines results.

This approach exploits the fact that when a parallel beam enters a lens at some angle, the focal point for the beam is located not on the optical axis but is displaced. If an input beam comprises a series of parallel beams hitting the focusing lens 710 at different angles, there are several focal points in the focal plane, where a displacement is proportional to the incidence angle and the focal length of the lens. In other words, the nth beamlet displacement along the y-axis (from the x-axis) is given by the following expression.

Δₙ=f*Θₓₙ (14)

This opens up the path to build an array of focal points characterized by a regular interval between foci. The beam is split into a subset of individual beamlets entering the lens at different angles. A number of options for creating a vertical beamlet array from this are now discussed.

Referring next to FIG. 5B, there is shown a perspective view of a first example implementation according to the approach of FIG. 5A. This uses a two-element arrangement to produce a one-dimensional vertical array of focal lines. The arrangement comprises: a planar zone plate or multifaceted prism 700; and a cylindrical lens 710. Eight different beamlets are shown: four above the x-axis O (labelled 1, 2, 3, 4); and four below the x-axis 0 (labelled −1, −2, −3, −4).

The multifaceted prism 700 thus has a number of facets equal to the amount of required beamlets. Angled surfaces of the prism 700 are flat. In this drawing, 8 beamlets are shown. The cylindrical lens 710 collects individual beamlets into the focal points. Calculations for individual facets may proceed as follows. First, a focal length, f, may be chosen for the cylindrical lens based on a design non-interference requirement, specifically proximity to other constructive elements and/or lenses. The exemplary calculations may be made with f=50 mm. This may be chosen so as to place the assembly of FIG. 5A between the lens shown in FIG. 2C and the object plane. The focal lengths of segments in FIG. 2C may be about 80 mm, so, having f=50 mm for the second, vertical arrangement may be safe. The prism 700 and cylindrical lens 710 may have a form-factor of around 30×30 mm.

Then, equation (14) above thus allows the calculations values of angles Θₓᵢ for individual beamlets, assuming equidistant locations of focal points with a step Δ=Δ₂−Δ₁=Δ₃−Δ₂=Δ₄−Δ₃, etc. With angles Θₓᵢ calculated, angles αᵢ can be calculated for individual facets.

Referring next to FIG. 5C, there is schematically depicted a cross-section through a facet of a zone plate 700 as shown in FIG. 5B, showing a beamlet path according to an angle of the front surface 705 of the facet of the zone plate 700. An example beamlet 750 is directed at the front surface 705 of the facet of the zone plate 700. The angle of the nth facet to the vertical (y) axis, αₙ, and a beamlet angle to the x-axis, Θₙ, at the rear surface of the zone plate facet (prism) are shown. Calculation of these angles for individual facets may be determined from the following expressions.

sin Θₙ=n*sin(αₙ−βₙ) (15)

sin αₙ=n*sin βₙ (16)

The pair of equations (15) and (16) can be simultaneously solved to eliminate the angle β. This allows a relationship between an angle of a beam diversion from the optical axis Oxi and an angle αᵢ of a facet to be determined from the following expression.

sin Θₙ=sin αₙ*[\sqrt{n²−(sin αₙ)²}−\sqrt{1−(sin αₙ)²}] (17)

A simplified form of this equation may be found for paraxial optics.

$$sin {Θ}_{n} ≃ {Θ}_{n} ≃ {∝}_{n} * ( n - 1 ) ( 1 + \frac{{α}_{n}^{2}}{2 {n}^{2}} ) \qquad ( 18 )$$

An exemplary calculation for 8 facets or zones is now discussed, based on the following assumptions: focal length, f=50 mm; prism made of fused silica having a refraction index N=1.5608; there is symmetry in the sagittal plane of the zone plate. The angles are now detailed with reference to FIG. 5D, in which there is schematically shown a multi-faceted prism 700 in cross-section based on the facet shown in FIG. 5C. The angle of each facet to the vertical (y) axis, ai, is shown. Since the multi-faceted prism 700 is symmetric against the x-axis, the angles are also symmetric.

The angles can be determined based on the expression,

Δ=h/(2f) (19),

where h is the distance between fragmentation locations (for example, the inter-cell in an array of ion traps, each of which may be a μEST) and f is the focal length of the cylindrical lens 710.

In an example, assume h=0.5 mm, f=50 mm and n=1.5608. Then, the angles (in radians) relative to the vertical (y) axis, αᵢ, are as follows:

| | | | | | | | | |
|---|---|---|---|---|---|---|---|---|
| α₁ | = | α₋₁ | = | Δ/2/ | = | 0.0045 rad | = | 0.26 deg; |
| | | | | (n − 1) | | | | |
| α₂ | = | α₋₂ | = | 3/2 Δ/ | = | 0.013 rad | = | 0.77 deg; |
| | | | | (n − 1) | | | | |
| α₃ | = | α₋₃ | = | 5/2 Δ/ | = | 0.23 rad | = | 1.28 deg; |
| | | | | (n − 1) | | | | |
| α₄ | = | α₋₄ | = | 7/2 Δ/ | = | 0.031 rad | = | 1.79 deg. |
| | | | | (n − 1) | | | | |

All these angles are small (less than 2 degrees), making a paraxial optics approximation valid.

A planar zone plate or multi-faceted prism may be more straightforward to manufacture than other implementations due to flat surfaces of the prism. However, the combination of this with a cylindrical lens (or equivalent) thus requires two optical elements, which may need to be precisely aligned near the target array. Another variant of this approach could be a mirror array, including a digital micromirror device as marketed by Texas Instruments Inc.

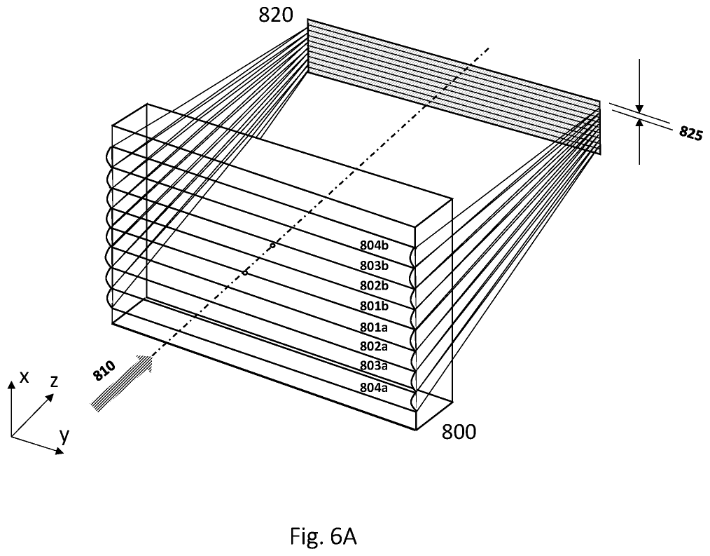

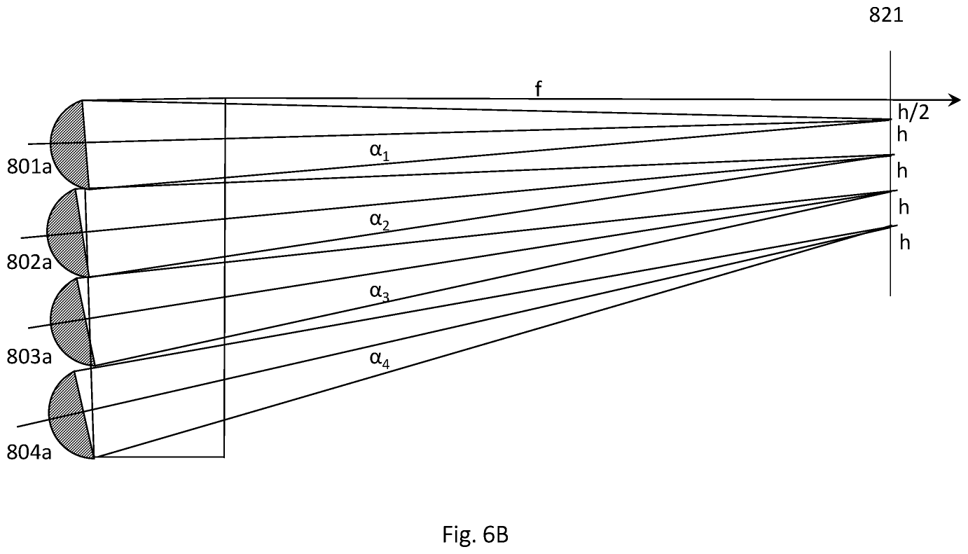

An alternative approach may be based on an array of cylindrical micro-lenses. In this case, a separate prism and focusing lens are not needed, as a single optical device can be used. Referring now to FIG. 6A, there is illustrated a perspective view of an array of horizontally elongated cylindrical micro-lenses having tilted axes, in order to form beamlets at multiple focal points in a one-dimensional (vertical) array. In this specific example, 8 focal points are shown. Similarly to the SCL of FIG. 3A, the array 800 has 8 micro-lenses (801a, 802a, 803a, 804a, 801 b, 802b, 803b, 804b), used for splitting and focusing beam 810. However, there are some differences between this design and that shown FIGS. 2C and 3A. In the design of FIG. 6A, all segments have identical curvature radius, meaning the focal length for all of them is the same. For comparison, the curvature radius differs between segments for the SCL of FIG. 2C (as discussed above with reference to FIG. 4B). Also, the optical axes of these segments are tilted at angles similar to calculated angles in equation (18) above, as will be discussed below.

The result of this focusing is a one-dimensional spaced array of beamlets 820, spaced in the (vertical) x-dimension. The array pitch 825 (spacing between the beamlets) corresponds with the cell size and is typically 0.1-0.5 mm. Unlike the arrangement of FIG. 5B, the cylindrical micro-lenses 800 of FIG. 6A requires only one optical element, but a much more complex one, with high requirements on accuracy of each lens. Both accurate lens profile (curvature of specific radius) and accurate lens tilt angle are desirably set accurately, making the array 800 more difficult to implement than a SCL.

Referring then to FIG. 6B, there is shown a schematic cross-section of some of the cylindrical micro-lenses of FIG. 6A, showing the titled axes more clearly. The tilt angles of the cylindrical micro-lenses are given by the following expressions, where h is the distance between fragmentation locations (as discussed above) and f is the focal length of the micro-lenses.
sin(α₁)=h/(2*f);
sin(α₂)=3h/(2*f);
sin(α₃)=5h/(2*f);
sin(α₄)=7h/(2*f).

It will be understood that α₁ is the tilt angle for the micro-lenses 801a, α₂ is the tilt angle for the micro-lens 802a, α₃ is the tilt angle for the micro-lens 803a and α₄ is the tilt angle for the micro-lens 804a. The tilt angle for the micro-lens 801b is α₋₁ which is equal to α₁, the tilt angle for the micro-lens 802b is α₋₂ which is equal to α₂, the tilt angle for the micro-lens 803b is α₋₃ which is equal to α₃ and the tilt angle for the micro-lens 804b is α₋₄ which is equal to α₄.

Using the assumptions of the example above, in which h=0.5 mm, f=50 mm, these angles can be calculated as follows.

α₁ = α₋₁ = 0.005 rad = 0.29 deg;
α₂ = α₋₂ = 0.015 rad = 0.86 deg;
α₃ = α₋₃ = 0.025 rad = 1.43 deg; and
α₄ = α₋₄ = 0.035 rad = 2.01 deg.

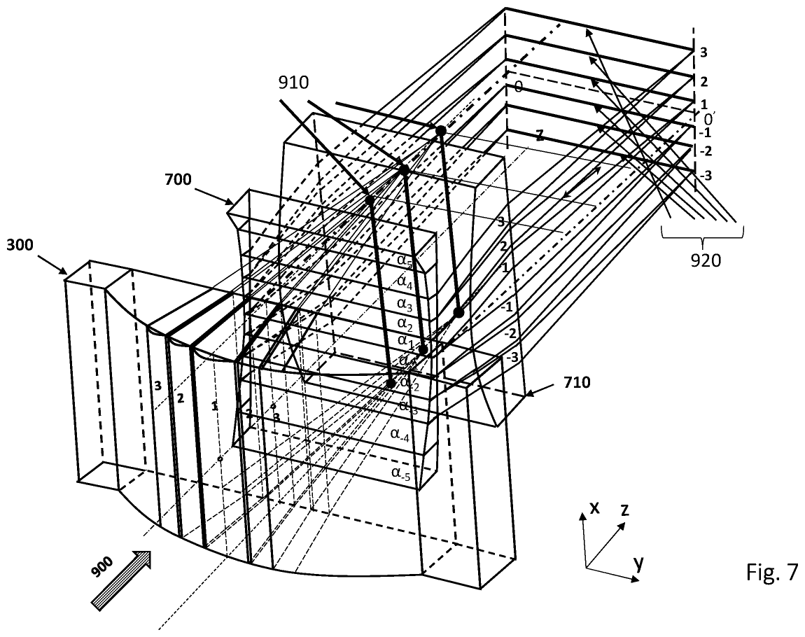

Reference is now made to FIG. 7, showing a schematic perspective view of an optical arrangement for creating a two-dimensional array of beamlets based on a SCL (as shown in FIG. 2C) and a combination of a multi-faceted prism with a cylindrical lens (as shown in FIG. 5B). This may be relatively straightforward to manufacture. It can be seen that a parallel beam 900 passing through the SCL 300 provides an array of horizontal focal points 910 (only the first three are shown) and the multi-faceted prism with a cylindrical lens following adds vertical focal points 920 (three either side of the center are shown). The result is a two-dimensional array of focal points with a respective beamlet focused at each focal point.

Alternative optical arrangements for splitting the beam and focusing the beamlets can be considered. For example, an arrangement based on a bundle of optical fibers will be detailed further below.

Returning to the general sense discussed above, preferable, optional and/or advantageous features may be considered, as will now be presented.

For example, the optical arrangement may comprise a zone plate (formed by a lens arrangement based on a Fresnel lens structure) configured to split the optical beam into the multiple beamlets. The zone plate may be planar or formed as a segmented cylindrical lens (SCL) or a multi-faceted prism.

The optical arrangement may further comprise a cylindrical lens, configured to configured to receive and refract the beam or beam. The zone plate may be integrated with the cylindrical lens. A zone plate (which may comprise a SCL part) may be configured to focus each beamlet at the respective plane and the integration of the cylindrical lens with the zone plate may be achieved by adaptation of the front surface and/or back surface of the cylindrical lens.

Where the zone plate is formed by a SCL part configured to focus each beamlet at a respective plane, the SCL part may have segments that are symmetrical about a sagittal (median) plane. In this case, segments equidistant the sagittal plane may be used to focus a beamlet at a common plane. Alternatively, the SCL part may have non-symmetrically arranged segments. Then, each segment may focus a beamlet at a distinct respective plane.

In embodiments, the optical arrangement may comprise an array of tilted micro-lenses configured to split the optical beam into the multiple beamlets and focus each beamlet at the respective plane.

In embodiments, the optical arrangement may comprise a fiber optic bundle configured to split the optical beam into the multiple beamlets. The optical arrangement may further comprise an array of lenses (in particular, micro-lenses), each lens aligned with a respective fiber optic of the fiber optic bundle, to focus the respective beamlet at the respective plane.

A first part of the optical arrangement is advantageously configured to split the beam in a first direction, for instance horizontal (this may be a direction parallel to a width of the first part, which may be a y-dimension or a direction perpendicular to a width of the first part, which may be a depth or z-dimension). This may allow each beamlet to be focused at a line that is spaced apart from other lines in the first direction. In embodiments, the first part is formed by a first zone plate, which may also include a cylindrical lens or SCL part. Other options for the first part may include those discussed above (or elsewhere herein).

A second part of the optical arrangement may be configured to split the beam in a second direction, orthogonal to the first direction (for example vertical or x-dimension). This may permit each beamlet to be focused at a point that is spaced apart from other points in the second direction (thereby splitting and focusing the beam in two dimensions). Advantageously, the second part is arranged to receive an optical output from the first part (although the opposite arrangement may be possible in some implementations). In one option, the second part may be formed of a second zone plate and a cylindrical lens part. According to this option, the cylindrical lens part may be integrated with the second zone plate in some embodiments. For example, the zone plate may be in the form of a multi-faceted prism with the cylindrical lens integrated into its front surfaces. The multi-faceted prism may then have flat angled back surfaces. According to a second option, the second part may be formed of an array of tilted micro-lenses. Other options for the second part may include those discussed above (or elsewhere herein).

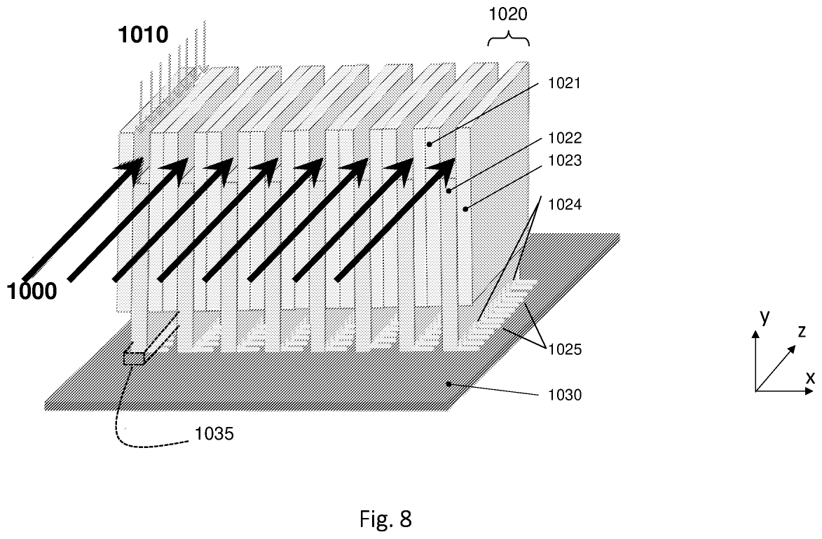

Referring now to FIG. 8, there is illustrated a two-dimensional array of stacked micro-electrostatic traps (uESTs). These are in accordance with the disclosures of U.S. patent application Ser. No. 17/823,618 filed on 31 Aug. 2022. In this example, an 8×8 array of uESTs is shown. The direction of the optical beamlets (UV) 1000 for photofragmentation is shown, as well the directions in which ion beamlets 1010 enter the μEST modules 1020 (each with 8 traps). It can be seen that eight such μEST modules 1020 are shown. These are mounted on a motherboard chip 1030.

Each μEST module 1020 comprises: at least one two-sided μEST chip 1021; a spacer chip 1022. The μEST module 1020 at the end of the array has a two-sided μEST chip 1021 and an end-piece μEST chip 1023, whereas the other μEST modules share two two-sided μEST chips 1021. At the base of each μEST module 1020, back contact pads 1024 are provided on the spacer chip 1022. These couple with contact pads 1025 on the motherboard chip 1030. Through-wafer Deep Reactive-Ion Etching (DRIE) slots 1035 in the motherboard chip 1030 accommodate the eight spacer chips 1022.

The optical beamlets 1000 provided to this array of μESTs can be generated by the optical arrangements proposed herein, on the example of 8 rows of traps, with 8 traps in each row. For the sake of completeness, please note a 90-degree difference in orientation between FIGS. 7 and 8 as indicated by x and y arrows. The dimensions of optical elements are desirably matched to the pitch of ion traps in each direction. Additional optics may be used if adjustment of pitch is needed due to tolerances.

It can thus be seen that a two-dimensional array of ion trap locations is provided (in the x-z plane) by the μEST module 1020. Ions in an ion beam parallel to the y-dimension can be introduced into any one of the ions traps by raster scanning the ion beam in the x and z directions. The optical (laser) beam 1000 is introduced from the side (parallel to the z-dimension) and the two-dimensional (x-z) array of focal points is aligned to that two-dimensional array of ion trap locations. It can also be understood that a one dimensional array of focal lines could alternatively be aligned in this way. Coating of any of the optical arrangements discussed above is possible. An anti-reflective coating may optionally be used to reduce losses (each surface passing may give up to 4% loss). This may be applied on one, some or all elements, lenses and prisms. It may be especially useful for multi-lens arrangements.

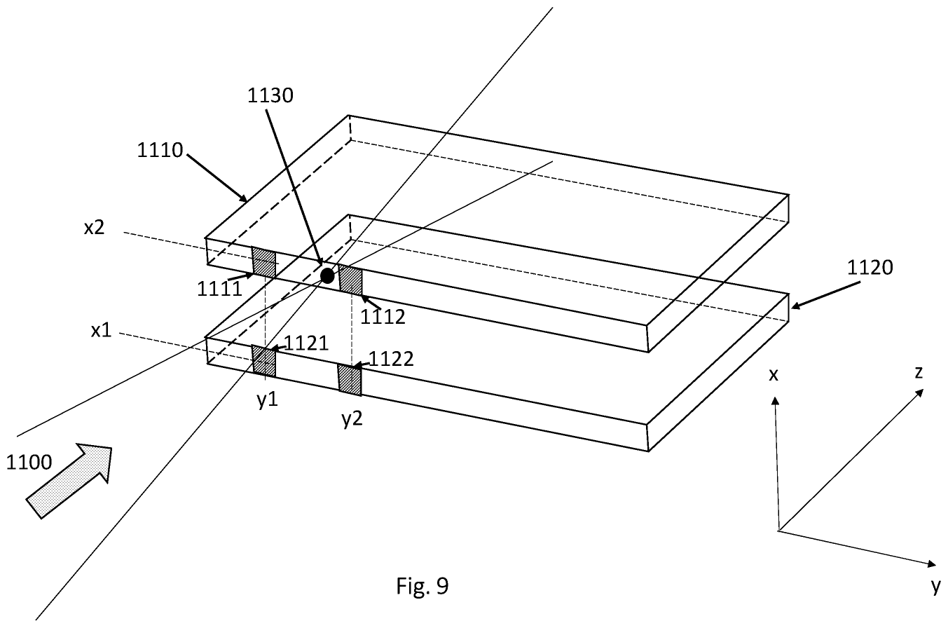

Alignment of the beamlets to the fragmentation location in each ion trap is particularly advantageous in this context. An example approach for two-dimensional (x, y) alignment is now discussed with reference to FIG. 9, in which there is shown a perspective view of elements on an ion trap with additional features for optical beam alignment. The ion trap comprises: a first (upper) electrode 1110; and a second (lower) electrode 1120. Ions are trapped in a trapping region between the first electrode 1110 and the second electrode 1120. The electrodes 1110, 1120 are typically formed on adjacent integrated circuits (or chips), for example as shown in FIG. 8. A laser beam (or more precisely, beamlet) 1100 is directed into the trapping region for the purpose of photofragmentation. As shown, alignment in the x-direction and y-direction is desirable for improving fragmentation efficiency and effectiveness.

Correct alignment can be assisted using detection pads. Specifically, four detection pads are shown in this example: a first detection pad 1111 on the first electrode 1110; a second detection pad 1112 on the first electrode 1110; a third detection pad 1121 on the second electrode 1120; and a fourth detection pad 1122 on the second electrode 1120. The positions of the detection pads are desirably around the optimum position of the laser beam 1100 on the front edge of ion trap electrodes.

Additional optics (not shown) may then be used to raster the laser beam 1100, preferably at milliradian level in both x and y dimensions. Doing so may allow a photoelectron signal to be detected on each of pads 1111, 1112, 1121, 1122 sequentially by an electrometer (not shown). Depending on timing, duration and rise-time of the signal, the actual beam size and position in working mode could be established. The laser beamlet 1100 may then be directed to a target position 1130 accordingly.

This approach may provide an initial beam alignment on the target. Alternatives are possible. For example, a mask can be placed on all elements on the SCL 300 of FIG. 2C (with reference to FIG. 7). Similar masking may be applied to the multi-faceted prism 700 shown in FIG. 5A (and/or FIG. 7A). After masking, only one element may be active. With this single element illuminated by a laser, a micro-positioner (with a step motor to count steps for x and y displacement) may be used to go through all four pads 1111, 1112, 1121, 1122.

A camera and register may then be used to detect when the laser hits each pad one by one while counting steps for both directions. The design geometry may dictate how the pads positions are referenced to a position where ions are expected to arrive. From step counts for x1, x2, y1, y2 positions shown in FIG. 9, the step counts for the target 1130.

In the case of a μEST array, ions may be irradiated at their turning points, as they oscillate inside each ion trap. If all ions of interest arrive simultaneously to their turning points, then a single laser pulse might be sufficient to provide a sufficient fluence for fragmentation. However, if ions are not synchronized, then a multitude of pulses may be used, so that eventually every ion in the trap is fragmented.

In a typical example, a laser beam of 2 to 3 mm diameter and energy 5 to 10 mJ is directed to 8×8 array of traps with a separation of 0.5 mm in both x and z directions. With an ion beam size of 20 microns, a fluence of 1 J/cm² could be achieved in each of 64 traps even with 5-10× losses of photons on optical elements.

In addition to the already-mentioned alternative embodiment based on a digital micromirror device, it is also feasible to foresee an embodiment based on fiber-optic bundle terminated with a micro-lens array. Each lens of a micro-lens array may generally have a diameter less than a millimeter and often as small as 10 μm. A pitch of the bundle of fiber-optics and a pitch of the micro-lenses is advantageously matched to a pitch of ion trap array. In this case, it may be possible to achieve the same effect as shown above for lenses based on Fresnel principles and zone plates.

According to a further generalized aspect of the disclosure, there may be considered a photofragmentation system, comprising: an optical arrangement as disclosed herein; and an array of ion traps, each of the spatially-separated locations corresponding with a respective trapping region of one of the ion traps. Preferably, the ion traps are μESTs or RF traps. In embodiments, the ion traps have parallel longitudinal axes and/or axes for receiving ions, the laser and optical pulse being applied in a direction orthogonal to the longitudinal axes and/or axes for receiving ions. Each ion trap may be formed by one or more planar electrode arrangements, for example formed on a chip (or other type of integrated circuit). The array may be formed of stacked chip and/or the longitudinal axes may be defined by respective chips.

The ion traps in the array are typically arranged in two dimensions. The optical arrangement may then be configured to focus each beamlet at a respective point in the two dimensions. Each point corresponds with a respective trapping region of one of the array of ion traps.

Each ion trap may comprise detection pads located around the region in which the beamlet is to be focused. For example, four detection pads may be provided. The detection pads may be located on portions of electrodes of the ion trap, for example on a surface of the ion trap proximal to the beamlet arrival (which may be perpendicular from a surface of the electrode defining an extent of a trapping region). Then, the ion fragmentation system may further comprise: additional optics, configured to raster the laser beam (preferably in two dimensions), such that the detection pads detect the raster beamlet; and a controller, configured to align the beamlets based on an output from the detection pads. A corresponding method of beamlet alignment may also be considered.

The photofragmentation system typically further comprises a laser, configured to emit a pulse at the optical arrangement for processing. The energy output of the laser is advantageously sufficient for each beamlet to photofragment ions. Additionally or alternatively, the laser and optical arrangement may be configured to achieve an optical fluence of at least 0.01 J/cm² at each of the plurality of locations.

Although embodiments according to the disclosure have been described with reference to particular types of devices and applications (particularly mass spectrometry) and the embodiments have particular advantages in such case, as discussed herein, approaches according to the disclosure may be applied to other types of device and/or application. In particular, the devices according to the disclosure may be used for other applications, especially where multiple beams (beamlets) are used for photofragmentation or photodissociation. The specific structure, arrangement and operational details (for example, parameters) of the processes described, whilst potentially advantageous (especially in view of known configurations and capabilities), may be varied significantly to arrive at modes of operation with similar or identical performance. Other types of beam splitter and/or focusing may be considered from those disclosed herein. Certain features may be omitted or substituted, for example as indicated herein. Each feature disclosed in this specification, unless stated otherwise, may be replaced by alternative features serving the same, equivalent or similar purpose. Thus, unless stated otherwise, each feature disclosed is one example only of a generic series of equivalent or similar features.

Embodiments are described in which the front surface or the back surface of the zone plate are modified to integrate a SCL. This is because the optical industry routinely performs precise processing of opposite surfaces of an optical element lens when they have identical spherical symmetry. Thus examples described herein may be implemented by bi-commercial symmetric-convex/concave lenses (identical curvature radii on opposite sides) or so-called Best Form lenses (different radii on opposite sides). Cylindrical lenses typically have only one non-flat surface. However, it may be possible to achieve the same results by modifying both the front and back surfaces (albeit significantly more difficult and not easy to manufacture). In other words, a combination of profiles on opposite sides of a single optical element might be possible.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an ion multipole device) means “one or more” (for instance, one or more ion multipole device). Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the disclosure. That is, an element termed a “first” element may instead be termed a “second” element and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

All literature and similar materials cited in this disclosure, including but not limited to patents, patent applications, articles, books, treaties and internet web pages are expressly incorporated by reference in their entirety for any purpose. Unless otherwise described, all technical and scientific terms used herein have a meaning as is commonly understood by one of ordinary skill in the art to which the various embodiments described herein belongs.

1. An optical arrangement, configured to split an optical beam into multiple beamlets and focus each beamlet at a respective line, each line defined with reference to a respective spatially-separated location across at least one dimension, such that each of at least one of the beamlets photofragments distinct ions confined at the respective spatially-separated location.

2. The optical arrangement of claim 1, further comprising:
a zone plate configured to split the optical beam into the multiple beamlets.

3. The optical arrangement of claim 2, wherein the zone plate is planar or is formed as a segmented cylindrical lens (SCL) or multi-faceted prism.

4. The optical arrangement of claim 2, further comprising:
a cylindrical lens, configured to receive and refract the beam or beamlets.

5. The optical arrangement of claim 4, wherein the zone plate is integrated with the cylindrical lens.

6. The optical arrangement of claim 5, wherein the zone plate is configured to focus each beamlet at the respective line and the integration of the zone plate with the cylindrical lens is achieved by adaptation of a front surface or a back surface of the cylindrical lens.

7. The optical arrangement of claim 2, wherein the zone plate is formed as a SCL and wherein the SCL has segments that are symmetrical about a sagittal plane.

8. The optical arrangement of claim 1, wherein a first part of the optical arrangement is configured to split the beam in a first direction, such that each beamlet is focused at a line that is spaced apart from other lines in the first direction.

9. The optical arrangement of claim 8, wherein the first part is formed by a first zone plate.

10. The optical arrangement of claim 8, wherein a second part of the optical arrangement is configured to split the beamlets in a second direction, orthogonal to the first direction, such that each beamlet is focused at a point that is spaced apart from other points in the second direction.

11. The optical arrangement of claim 10, wherein the second part is formed of a second zone plate and a cylindrical lens part or wherein the second part is formed of an array of tilted micro-lenses.

12. The optical arrangement of claim 10, wherein the second part is formed of a cylindrical lens part integrated with a second zone plate.

13. The optical arrangement of claim 12, wherein the zone plate is in the form of a multi-faceted prism with the cylindrical lens integrated into its front surfaces and flat angled back surfaces.

14. A photofragmentation system, comprising:
an optical arrangement configured to split an optical beam into multiple beamlets and focus each beamlet at a respective line, each line defined with reference to a respective spatially-separated location across at least one dimension, such that each of at least one of the beamlets photofragments distinct ions confined at the respective spatially-separated location; and
an array of ion traps, each of the spatially-separated locations corresponding with a respective trapping region of one of the ion traps.

15. The photofragmentation system of claim 14, wherein the array of ion traps is arranged in two dimensions and the optical arrangement is configured to focus each beamlet at a respective point in the two dimensions that corresponds with respective trapping region of one of the ion traps.

16. The photofragmentation system of claim 14, wherein
the ion traps are μESTs or RF traps; and/or
the ion traps have parallel longitudinal axes and/or axes for receiving ions, the optical beam being applied in a direction orthogonal to the longitudinal axes and/or axes for receiving ions.

17. The photofragmentation system of claim 14, wherein at least one ion trap or at least one row of ion traps from the array of ion traps comprises detection pads located around a region in which the beamlet is to be focused, the photofragmentation system further comprising:
additional optics, configured to raster the optical beam, such that the detection pads detect the rastered beamlet; and
a controller, configured to align the beamlets based on an output from the detection pads.

18. The photofragmentation system of claim 14, further comprising:
an ultraviolet or infrared laser, configured to emit the optical beam at the optical arrangement.

19. The photofragmentation system of claim 18, wherein:
an energy output of the laser is sufficient for each beamlet to photofragment ions; and/or
the laser and optical arrangement are configured to achieve an optical fluence of at least 0.01 J/cm² at each of the spatially-separated locations.

20. A method of processing an optical beam for photofragmentation, comprising:
splitting the optical beam into multiple beamlets; and
focusing each beamlet at a respective line, each line defined with reference to a respective spatially-separated location across at least one dimension, such that each of at least one of the beamlets photofragments distinct ions confined at the respective spatially-separated location.
